(19) United States
(12) Patent Application Publication
(10) Pub. No.: US 2022/0011614 A1
(43) Pub. Date: Jan. 13, 2022

(54) LIQUID CRYSTAL DISPLAY PANEL

(71) Applicant: TCL CHINA STAR OPTOELECTRONICS TECHNOLOGY CO., LTD, ShenZhen, Guangdong (CN)

(72) Inventor: Yihe Zhang, ShenZhen, Guangdong (CN)

(21) Appl. No.: 17/251,791

(22) PCT Filed: Sep. 23, 2020
(86) PCT No.: PCT/CN2020/116944

§ 371 Date: Dec. 12, 2020

(30) Foreign Application Priority Data
Jul. 8, 2020 (CN) 202010653100.X

(51) Int. Cl. G02F 1/1368; G02F 1/1362

(52) U.S. Cl. CPC G02F 1/1368; G02F 1/136222

(57) ABSTRACT

The present disclosure provides a liquid crystal display panel, including a color filter substrate, an array substrate disposed opposite to the color filter substrate, and a liquid crystal layer disposed between the color filter substrate and the array substrate. The array substrate includes a base substrate, a thin film transistor disposed on the base substrate, a pixel electrode, and a distributed Bragg reflective film disposed on the pixel electrode. The thin film transistor includes a source electrode and drain electrode. The drain electrode includes an extension part. The pixel electrode is disposed on the extension part of the drain electrode and electrically connected with the drain electrode.

### CROSS-REFERENCE TO RELATED APPLICATION

The present disclosure claims priority from a Chinese patent application filed with the Chinese Patent Office on Jul. 8, 2020 and with application number 202010653100.X, the title of which is “LIQUID CRYSTAL DISPLAY PANEL” and entire contents of which are incorporated herein by reference.

### FIELD OF INVENTION

The present disclosure relates to the field of display technologies, and particularly to a liquid crystal display panel.

### BACKGROUND OF INVENTION

With the rapid development of e-books, there is a growing demand for eye protection on monitors. In recent years, e-ink technology has been widely used and developed. However, e-ink is usually limited to a display mode of black, white, and gray, and its response time is long, which cannot meet people's requirements for color pictures and videos. Therefore, it is necessary to find a better solution.

Liquid crystal displays (LCD) are widely used in many electronic products in daily life, such as mobile phones, digital cameras, and computers, etc. Because of their light weight, small size, low electromagnetic interference, low power consumption, and other excellent characteristics, LCD displays are widely used in people's daily production and life and have become a mainstream in the current display field. Particularly, because backlights with high power consumption are omitted, all-reflective liquid crystal displays can display normally with lower power consumption while meeting requirements of full color and a high refresh rate. However, since all-reflective liquid crystal displays have no backlights, strong ambient light is required for display. Generally, a reflective rate of all-reflective liquid crystal display devices is only about 10%, and a utilization rate of external ambient light is low. All-reflective liquid crystal displays cannot display normally in a dimmer ambient light, so applications of all-reflective liquid crystal displays in specific occasions are limited.

Therefore, the prior art has defects that need to be solved urgently.

### Technical Problems

The present disclosure provides a liquid crystal display panel, which can solve a problem that conventional all-reflective liquid crystal display panels cannot display normally under a darker ambient light due to low utilization rate of external ambient light.

### Technical Solutions

In order to solve the above problems, technical solutions provided by the present disclosure are as follows:

The present disclosure provides a liquid crystal display panel, including a color filter substrate, an array substrate disposed opposite to the color filter substrate, and a liquid crystal layer disposed between the color filter substrate and the array substrate. The array substrate includes:

a base substrate;

a thin film transistor disposed on the base substrate, the thin film transistor comprising a source electrode and a drain electrode, and the drain electrode comprising an extension part;

a pixel electrode disposed on the extension part of the drain electrode and electrically connected with the drain electrode; and

a distributed Bragg reflective film disposed on the pixel electrode.

In the liquid crystal display panel of the present disclosure, the distributed Bragg reflective film comprises M stacked reflective film modules, and each of the reflective film modules comprises N sub-reflective layers, wherein M is a positive integer greater than or equal to 1, and N is a positive integer greater than or equal to 2.

In the liquid crystal display panel of the present disclosure, refractive rates of different sub-reflective layers in each of the reflective film modules are different.

In the liquid crystal display panel of the present disclosure, the refractive rates of the sub-reflective layers in a same reflective film module decrease layer by layer from a side close to the pixel electrode to a side away from the pixel electrode.

In the liquid crystal display panel of the present disclosure, a thickness of each of the reflective film modules is a quarter-wavelength of an odd multiple.

In the liquid crystal display panel of the present disclosure, the reflective film modules of the distributed Bragg reflective film have different thicknesses.

In the liquid crystal display panel of the present disclosure, an orthographic projection of the extension part of the drain electrode on the base substrate coincides with an orthographic projection of the pixel electrode on the base substrate.

In the liquid crystal display panel of the present disclosure, an orthographic projection of the distributed Bragg reflective film on the base substrate at least covers the orthographic projection of the pixel electrode on the base substrate.

In the liquid crystal display panel of the present disclosure, the distributed Bragg reflective film is disposed on the pixel electrode and the thin film transistor, and a surface of the distributed Bragg reflective film facing the color filter substrate is a flat surface.

In the liquid crystal display panel of the present disclosure, a polarizer is disposed on a side of the color filter substrate facing away from the array substrate, and a scattering film is disposed on a side of the polarizer facing away from the color filter substrate.

In order to solve the above problems, the present disclosure also provided a liquid crystal display panel, including a color filter substrate, an array substrate disposed opposite to the color filter substrate, and a liquid crystal layer disposed between the color filter substrate and the array substrate. The color filter substrate includes a color resistance and a common electrode, and the array substrate includes:

a base substrate;

a thin film transistor disposed on the base substrate, the thin film transistor comprising a source electrode and a drain electrode, and the drain electrode comprising an extension part;

a pixel electrode disposed on the extension part of the drain electrode and electrically connected with the drain electrode; and

a distributed Bragg reflective film disposed on the pixel electrode.

In the liquid crystal display panel of the present disclosure, the distributed Bragg reflective film comprises M stacked reflective film modules, and each of the reflective film modules comprises N sub-reflective layers, wherein M is a positive integer greater than or equal to 1, and N is a positive integer greater than or equal to 2.

In the liquid crystal display panel of the present disclosure, refractive rates of different sub-reflective layers in each of the reflective film modules are different.

In the liquid crystal display panel of the present disclosure, the refractive rates of the sub-reflective layers in a same reflective film module decrease layer by layer from a side close to the pixel electrode to a side away from the pixel electrode.

In the liquid crystal display panel of the present disclosure, a thickness of each of the reflective film modules is a quarter-wavelength of an odd multiple.

In the liquid crystal display panel of the present disclosure, the reflective film modules of the distributed Bragg reflective film have different thicknesses.

In the liquid crystal display panel of the present disclosure, an orthographic projection of the extension part of the drain electrode on the base substrate coincides with an orthographic projection of the pixel electrode on the base substrate.

In the liquid crystal display panel of the present disclosure, an orthographic projection of the distributed Bragg reflective film on the base substrate at least covers the orthographic projection of the pixel electrode on the base substrate.

In the liquid crystal display panel of the present disclosure, the distributed Bragg reflective film is disposed on the pixel electrode and the thin film transistor, and a surface of the distributed Bragg reflective film facing the color filter substrate is a flat surface.

In the liquid crystal display panel of the present disclosure, a polarizer is disposed on a side of the color filter substrate facing away from the array substrate, and a scattering film is disposed on a side of the polarizer facing away from the color filter substrate.

### Beneficial Effects

Beneficial effects of the present disclosure are: in the liquid crystal display panel provided by the present disclosure, a distributed Bragg reflective film is disposed on a metal reflective layer of the all-reflective liquid crystal display panel, so a reflective rate of the all-reflective liquid crystal display panel to light is increased, thereby solving the problem that conventional all-reflective liquid crystal display panels cannot display normally under a darker ambient light due to low utilization rate of external ambient light.

### DESCRIPTION OF DRAWINGS

In the following, embodiments of the present disclosure are described in detail accompanying with drawings to make the technical solutions of the present disclosure and other beneficial effects obvious.

FIG. 1 is a structural schematic view of a liquid crystal display panel provided in embodiment 1 of the present disclosure.

FIG. 2 is a structural schematic view of a distributed Bragg reflective film provided in embodiment 1 of the present disclosure.

FIG. 3 is a structural schematic view of a distributed Bragg reflective film of a liquid crystal display panel provided in embodiment 2 of the present disclosure.

### DETAILED DESCRIPTION OF EMBODIMENTS

The technical solutions in the embodiments of the present disclosure will be described clearly and completely hereafter with reference to the accompanying drawings. Apparently, the described embodiments are only a part of but not all embodiments of the present disclosure. All other embodiments obtained by persons of ordinary skill in the art based on the embodiments of the present disclosure without creative efforts shall fall within the protection scope of the present disclosure.

In description of the present disclosure, it should be understood that orientational or positional relationships represented by directional terms mentioned in the present disclosure, such as longitudinal, lateral, length, width, up, down, front, rear, left, right, vertical, horizontal, etc., are orientational or positional relationships based on the drawings, and are merely for the convenience of describing the present disclosure and simplifying the description, rather than indicating or implying that the device or element is intended to have a particular orientation, or is constructed and operated in a particular orientation, and therefore, should not be interpreted as a limitation of the application. In addition, terms such as “first” and “second” are used herein for purposes of description, and should not be interpreted as indication or implication of relative importance, or implied indication of a number of the technical features. Therefore, features limited by terms such as “first” and “second” can explicitly or impliedly include one or more than one of these features. In description of the disclosure, “a plurality of” means two or more than two, unless otherwise specified.

At present, since all-reflective liquid crystal display panels do not need backlight modules, screen display is realized by utilizing reflective of external light emitting into panel and then emitting from the pixel area, so all-reflective liquid crystal display panels have the advantages of low power consumption, light weight, and low costs. A conventional all-reflective liquid crystal display panel generally includes a metal reflective layer disposed between a first substrate electrode and a second substrate electrode. A reflective effect of a metal reflective layer on external ambient light is utilized to realize a display function of the all-reflective liquid crystal display panel. However, conventional all-reflective liquid crystal display panels cannot display normally in a dimmer ambient light due to low utilization rate of external ambient light, so development of all-reflective liquid crystal display panels is limited.

As such, a primary purpose of the present disclosure is to provide a liquid crystal display panel, so as to solve the problem that the conventional all-reflective liquid crystal display panels cannot display normally in a dimmer ambient light.

In addition, the conventional all-reflective liquid crystal display panel includes a metal reflective layer between the first substrate electrode and the second substrate electrode. In order to reduce adverse effects of the metal reflective layer on capacitors of the display device, a thicker organic protective layer needs to be disposed between the first substrate electrode and the metal reflective layer, and the organic protective layer needs to have a certain undulation to enable the metal reflective layer disposed on the organic protective layer to achieve good diffuse reflective effect. In this way, on one hand, process difficulty is increased, which leads to higher manufacturing costs; on the other hand, planarization of a contact area between a second substrate and a liquid crystal layer is affected, affecting the display effect.

As such, another purpose of the present disclosure is to provide a liquid crystal display panel to solve the problems.

In addition, due to low costs and other advantages, liquid crystal displays are widely used in various electronic equipment/display devices in various fields. With the rising popularity of e-books, conventional e-books using e-ink technology which only includes black, white, and gray displays can no longer meet people's requirements. Therefore, it is necessary to find a better solution that can achieve full-color display for e-books.

As such, another purpose of the present disclosure is to provide a liquid crystal display panel suitable for e-books, especially a liquid crystal display panel capable of realizing full-color display of e-books.

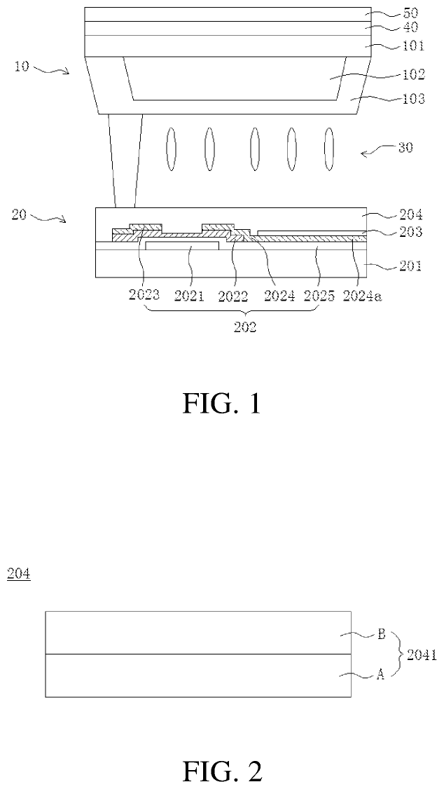

Referring to FIG. 1-FIG. 3, a liquid crystal display panel of the present disclosure includes a color filter substrate 10, an array substrate 20 disposed opposite to the color filter substrate 10, and a liquid crystal layer 30 disposed between the color filter substrate 10 and the array substrate 20. The color filter substrate 10 includes a first base substrate 101, a color resistance 102 disposed on the first base substrate 101, and a common electrode 103 on the color resistance 102.

The array substrate 20 includes a second base substrate 201 and a thin film transistor disposed on the second base substrate 201. The thin film transistor includes a gate electrode 2021, a source electrode 2023, and a drain electrode 2024. The drain electrode 2024 includes an extension part 2024a. The array substrate 20 further includes a pixel electrode 203 and a distributed Bragg reflective film 204 disposed on the pixel electrode 203. The pixel electrode 203 is disposed on the extension part 2024a of the drain electrode 2024 and electrically connected with the drain electrode 2024. Wherein, the liquid crystal display panel of the present disclosure is an all-reflective liquid crystal display panel, and the extension part 2024a is used as the metal reflective layer in the all-reflective liquid crystal display panel.

Of course, the liquid crystal display panel of the present disclosure further includes some other conventional films, such as a polarizer, a protective cover plate, etc., which are not limited herein.

The distributed Bragg reflective film 204 is a special all-dielectric reflective film, which is generally composed of alternately stacked compounds with different refractive rates, so periodic modulation of refractive rates occurs in one dimension of space, causing a strong interference phenomenon, and selective light reflective within a certain wavelength range is realized.

The distributed Bragg reflective film 204 provided by the present disclosure includes M stacked reflective film modules, and each of the reflective film modules includes N sub-reflective layers, wherein M is a positive integer greater than or equal to 1, and N is a positive integer greater than or equal to 2.

In the present disclosure, the distributed Bragg reflective film is integrated into the liquid crystal display panel, which can enhance a reflective rate of the all-reflective liquid crystal display panel and improve an external ambient light utilization rate of the all-reflective liquid crystal display panel, so the all-reflective liquid crystal display panel can display normally in a dimmer ambient light. In addition, a source/drain electrode is used as the metal reflective layer of a conventional total reflective liquid crystal display panel, and the organic protective layer and a protrusion structure in the conventional structure are omitted, which can effectively reduce manufacturing process of the reflective liquid crystal display panel. The distributed Bragg reflective layer can not only protect metal and avoid the reflectivity loss of the metal reflective layer caused by conventional transparent oxides, but also effectively improve the reflective rates of the metal. In addition, the liquid crystal display panel of the present disclosure can be applied to the field of e-book, thereby realizing full-color display of e-books.

Please describe the liquid crystal display panel of the disclosure in detail according to specific embodiments below.

### Embodiment 1

Referring to FIG. 1, FIG. 1 is a structural schematic view of a liquid crystal display panel provided in embodiment 1 of the present disclosure. The embodiment takes the thin film transistor as a bottom gate structure for illustration, and it is understood that the thin film transistor may be a top gate structure in other embodiments. An array driving layer 202 of an array substrate 20 includes, but is not limited to, a thin film transistor and an inorganic film layer. The thin film transistor includes a gate electrode 2021 disposed on a second base substrate 201, an active layer 2022 disposed on a gate insulating layer 2025 corresponding to the gate 2021, and a source electrode 2023 and a drain electrode 2024 electrically connected with the active layer 2022. The inorganic film layer includes a gate insulating layer 2025. A polarizer 40 is disposed on a side of a color filter substrate 10 facing away from the array substrate 20, and a scattering film 50 is disposed on a side of the polarizer 40 facing away from the color filter substrate 10.

Wherein, materials of the source electrode 2023 and the drain electrode 2024 include, but are not limited to, one or more alloys of copper, titanium, aluminum, silver, and other metal materials with good conductivity and reflectivity. For example, the materials can be a titanium-aluminum-titanium alloy. A material of a pixel electrode 203 includes, but is not limited to, indium tin oxide (ITO), zinc oxide (ZnO), etc.

An area of the pixel electrode 203 refers to an area required for normal display of a liquid crystal display panel. An orthographic projection of an extension part 2024a of the drain electrode 2024 on the base substrate 201 coincides with an orthographic projection of the pixel electrode 203 on the base substrate 201. That is, the extension 2024a of the drain electrode 2024 is used as a metal reflective layer in an all-reflective liquid crystal display panel, thereby reducing one of the processes (including film formation, photo, etching) for manufacturing the metal reflective layer.

An orthographic projection of a distributed Bragg reflective film 204 on the base substrate 201 at least covers the orthographic projection of the pixel electrode 203 on the base substrate 201.

Furthermore, the distributed Bragg reflective film 204 is entirely disposed on the pixel electrode 203 and the thin film transistor, and a surface of the distributed Bragg reflective film 204 facing the color filter substrate 10 is a flat surface. Therefore, the distributed Bragg reflective film 204 can not only protect the metal reflective layer (the source/drain electrode metal layer), but also flatten a surface of the array substrate 20, thereby omitting manufacture of a planarization layer in a conventional structure.

In addition, because the distributed Bragg reflective film 204 and the metal reflective layer form a specular reflection, a scattering film 50 needs to be added onto the polarizer 40 to compensate viewing angles.

Referring to FIG. 2, FIG. 2 is a structural schematic view of a distributed Bragg reflective film provided in embodiment 1 of the present disclosure. The distributed Bragg reflective film 204 of this embodiment includes a reflective film module 2041. The reflective film module 2041 includes a first sub-reflective layer A and a second sub-reflective layer B, and refractive rates of the first sub-reflective layer A and the second sub-reflective layer B are different. Wherein, the refractive rate of the first sub-reflective layer A is greater than the refractive rate of the second sub-reflective layer B, and the second sub-reflective layer B is disposed on a side of the first sub-reflective layer A away from the metal reflective layer.

Wherein, materials of sub-reflective layers include, but are not limited to, silicon nitride and silicon oxide, as long as refractive rates of the sub-reflective layers are different. In this embodiment, the material of the first sub-reflective layer A is silicon nitride, and the material of the second sub-reflecting layer B is silicon oxide.

A thickness of the reflective film module 2041 affects the light reflective rate of a metal reflective layer. Specifically: due to a half-wave loss (phase difference is π) of the reflective film module 2041, for example, when light is entering, a phase length condition of the reflective light is 2nd+λ/2=kλ (k=1, 2, 3 . . . ), and an optical thickness of the reflective film module obtained is 2041 nd=((2k−1)λ)/4. That is, when an optical thickness of the reflective film module 2041 is a quarter-wavelength of an odd multiple, a reflective light peak will occur, enhancing an external light reflective rate of the metal reflective layer. A peak reflective rate is sensitive to film thicknesses, especially when a film thickness is a quarter-wavelength when the external light reflective rate of the metal reflective layer is strongest.

Preferably, a film thickness of the reflective film module 2041 is a quarter-wavelength. During a process of external light entering a liquid crystal display panel and being reflected out the liquid crystal display panel through a metal reflective layer, thin film interference occurs to the light. That is, when the metal-reflected light passes through the distributed Bragg reflective film 204, constructive interference will occur, and the reflective light will be enhanced, overall showing increase in the reflective rate of the metal reflective layer. Therefore, this embodiment can improve an external ambient light utilization rate of an all-reflective liquid crystal display panel, so that the all-reflective liquid crystal display panel can display normally in a dimmer ambient light.

### Embodiment 2

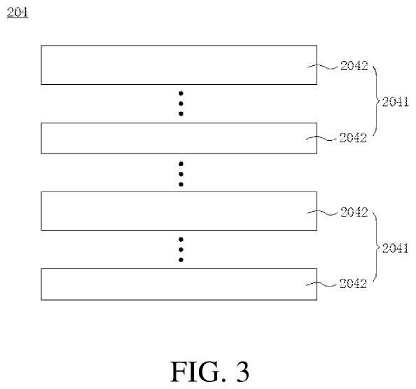

Referring to FIG. 3, FIG. 3 is a structural schematic view of a distributed Bragg reflective film of a liquid crystal display panel provided in embodiment 2 of the present disclosure. The structure of the liquid crystal display panel provided in this embodiment is same as or similar to the structure provided in embodiment 1, the differences being: the distributed Bragg reflective film 204 provided in this embodiment includes M reflective film modules 2041 repeatedly stacked, and each of the reflective film modules 2041 includes N sub-reflective layers 2042, wherein M is a positive integer greater than 1 (e.g., 2, 3, 4), and N is a positive integer greater than or equal to 2 (e.g., 2, 3, 4). Wherein, the refractive rates of the sub-reflective layers in a same reflective film module 2041 are different. Specifically, the refractive rates of the sub-reflective layers in the same reflective film module 2041 decrease layer by layer from a side close to a pixel electrode to a side away from the pixel electrode. A thickness of the reflective film module 2041 is a quarter-wavelength of an odd multiple, and the reflective film modules of the distributed Bragg reflective film have different thicknesses.

Referring to the following formula:

$$R = 1 - 4 \frac{{n}_{L}^{2 M}}{{n}_{H}} \frac{{n}_{s}}{{n}_{H}^{2}}$$

Wherein, R is a reflective rate, M is a number of reflective film modules, n_{H} is a highest of the refractive rates of the sub-reflective layers of the reflective film modules, n_{L} is a lowest of the refractive rates of the sub-reflective layers of the reflective film modules, and n_{S} is a refractive rate of the metal reflective layer.

It can be known from the above-mentioned formula that the greater the number of reflective film modules 2041, the higher the reflective rate of metal-reflected light. Therefore, compared with the liquid crystal display panel provided in the above-mentioned embodiment 1, the refractive rate of the metal reflective layer provided in this embodiment can be further increased.

In addition, because thicknesses of the reflective film modules 2041 of a distributed Bragg reflective film 204 provided in this embodiment are different, selectivity of single-film thicknesses to a quarter-wavelength, when reflectivity is strongest, will be reduced. That is, a multilayer reflective film module 2041 can be beneficial to reducing wavelength selectivity of reflective light, so that the reflective rates of different wavelengths are similar, thereby preventing a color-bias phenomenon. Wherein, the greater the number of reflective film modules 2041 of the distributed Bragg reflective film 204, the more effective it is in reducing color-bias.

In summary, in the liquid crystal display panel provided in the present disclosure, a distributed Bragg reflective film is provided on a metal reflective layer of the all-reflective liquid crystal display panel, so that light reflective rates of the all-reflective liquid crystal display panel are increased, thereby solving a problem that conventional all-reflective liquid crystal display panels cannot display normally under a dimmer ambient light due to low external ambient light utilization rate. Furthermore, wavelength selectivity of reflective light can be reduced, thereby making the reflective rate of different wavelengths similar and preventing a color-bias phenomenon. In addition, since the liquid crystal display panel of the present disclosure does not need a backlight, an external light can be directly used as a light source for full-color display by controlling a deflection of the liquid crystal.

In summary, although the present disclosure has been disclosed in the above preferred embodiments, the above preferred embodiments do not intend to limit the present disclosure. Various modifications and changes may be made by ordinary person skilled in the art without departing from the spirit and scope of this disclosure. Therefore, the scope of protection of this application is subject to the scope defined by the claims.

What is claimed is:

1. A liquid crystal display panel, comprising a color filter substrate, an array substrate disposed opposite to the color filter substrate, and a liquid crystal layer disposed between the color filter substrate and the array substrate, the array substrate comprising:
a base substrate;
a thin film transistor disposed on the base substrate, the thin film transistor comprising a source electrode and a drain electrode, and the drain electrode comprising an extension part;
a pixel electrode disposed on the extension part of the drain electrode and electrically connected with the drain electrode; and
a distributed Bragg reflective film disposed on the pixel electrode.

2. The liquid crystal display panel in claim 1, wherein the distributed Bragg reflective film comprises M stacked reflective film modules, and each of the reflective film modules comprises N sub-reflective layers, wherein M is a positive integer greater than or equal to 1, and N is a positive integer greater than or equal to 2.

3. The liquid crystal display panel in claim 2, wherein refractive rates of different sub-reflective layers in each of the reflective film modules are different.

4. The liquid crystal display panel in claim 3, wherein the refractive rates of the sub-reflective layers in a same reflective film module decrease layer by layer from a side close to the pixel electrode to a side away from the pixel electrode.

5. The liquid crystal display panel in claim 2, wherein a thickness of each of the reflective film modules is a quarter-wavelength of an odd multiple.

6. The liquid crystal display panel in claim 2, wherein the reflective film modules of the distributed Bragg reflective film have different thicknesses.

7. The liquid crystal display panel in claim 1, wherein an orthographic projection of the extension part of the drain electrode on the base substrate coincides with an orthographic projection of the pixel electrode on the base substrate.

8. The liquid crystal display panel in claim 7, wherein an orthographic projection of the distributed Bragg reflective film on the base substrate at least covers the orthographic projection of the pixel electrode on the base substrate.

9. The liquid crystal display panel in claim 8, wherein the distributed Bragg reflective film is disposed on the pixel electrode and the thin film transistor, and a surface of the distributed Bragg reflective film facing the color filter substrate is a flat surface.

10. The liquid crystal display panel in claim 1, wherein a polarizer is disposed on a side of the color filter substrate facing away from the array substrate, and a scattering film is disposed on a side of the polarizer facing away from the color filter substrate.

11. A liquid crystal display panel, comprising a color filter substrate, an array substrate disposed opposite to the color filter substrate, and a liquid crystal layer disposed between the color filter substrate and the array substrate; the color filter substrate comprises a color resistance and a common electrode, and the array substrate comprising:
a base substrate;
a thin film transistor disposed on the base substrate, the thin film transistor comprising a source electrode and a drain electrode, and the drain electrode comprising an extension part;
a pixel electrode disposed on the extension part of the drain electrode and electrically connected with the drain electrode; and
a distributed Bragg reflective film disposed on the pixel electrode.

12. The liquid crystal display panel in claim 11, wherein the distributed Bragg reflective film comprises M stacked reflective film modules, and each of the reflective film modules comprises N sub-reflective layers, wherein M is a positive integer greater than or equal to 1, and N is a positive integer greater than or equal to 2.

13. The liquid crystal display panel in claim 12, wherein refractive rates of different sub-reflective layers in each of the reflective film modules are different.

14. The liquid crystal display panel in claim 13, wherein the refractive rates of the sub-reflective layers in a same reflective film module decrease layer by layer from a side close to the pixel electrode to a side away from the pixel electrode.

15. The liquid crystal display panel in claim 12, wherein a thickness of each of the reflective film modules is a quarter-wavelength of an odd multiple.

16. The liquid crystal display panel in claim 12, wherein the reflective film modules of the distributed Bragg reflective film have different thicknesses.

17. The liquid crystal display panel in claim 11, wherein an orthographic projection of the extension part of the drain electrode on the base substrate coincides with an orthographic projection of the pixel electrode on the base substrate.

18. The liquid crystal display panel in claim 17, wherein an orthographic projection of the distributed Bragg reflective film on the base substrate at least covers the orthographic projection of the pixel electrode on the base substrate.

19. The liquid crystal display panel in claim 18, wherein the distributed Bragg reflective film is disposed on the pixel electrode and the thin film transistor, and a surface of the distributed Bragg reflective film facing the color filter substrate is a flat surface.

20. The liquid crystal display panel in claim 11, wherein a polarizer is disposed on a side of the color filter substrate facing away from the array substrate, and a scattering film is disposed on a side of the polarizer facing away from the color filter substrate.
